(19) United States
(12) Patent Application Publication
(10) Pub. No.: US 2026/0367389 A1
(43) Pub. Date: Nov. 19, 2026

(54) PROJECTION SYSTEM AND SIGNAL COMPENSATION METHOD THEREOF

(71) Applicant: Coretronic MEMS Corporation, MIAOLI COUNTY (TW)

(72) Inventors: Ming-Ching Wu, Miaoli County (TW); Hao-Chien Cheng, Miaoli County (TW)

(73) Assignee: Coretronic MEMS Corporation, MIAOLI COUNTY (TW)

(21) Appl. No.: 19/211,304

(22) Filed: May 19, 2025

(30) Foreign Application Priority Data
May 14, 2025 (TW) 114118138

(51) Int. Cl. G02B 26/10; G02B 26/08

(52) U.S. Cl. CPC G02B 26/101; G02B 26/0858

(57) ABSTRACT

A projection system includes a light source and a piezoelectric actuator. The piezoelectric actuator projects a light beam from the light source onto a target surface. The piezoelectric actuator includes a rotating member, a first actuation structure, a second actuation structure, and a sensing structure. The first actuation structure and the sensing structure are each coupled to the rotating member via the second actuation structure. A signal compensation method of the projection system includes inputting a driving signal to the first actuation structure and the second actuation structure to drive the rotating member to oscillate, and adjusting a driving amplitude of the driving signal based on a sensing amplitude of a sensing signal and/or adjusting a phase of the driving signal based on a phase variation of the sensing signal. The oscillating rotating member drives the sensing structure via the second actuation structure to deform and generate the sensing signal.

### CROSS-REFERENCE TO RELATED APPLICATION

This application claims the priority benefit of Taiwan application serial no. 114118138, filed on May 14, 2025. The entirety of the above-mentioned patent application is hereby incorporated by reference herein and made a part of this specification.

### BACKGROUND

### Technical Field

The present invention relates to a projection technology, and more particularly to a projection system and a signal compensation method thereof.

### Description of Related Art

With the advancement of applications such as optical projection, optical communication, and optical ranging LiDAR, reflective micromirror elements have become one of the focal points of development in related fields. Compared with micromirror elements fabricated through precision machining techniques, another type of micromirror element fabricated using micro-electro-mechanical systems (MEMS) combined with semiconductor process integration technology has gradually become mainstream due to its advantages of mass producibility, miniaturization, and integration with electronic circuits. According to different driving mechanisms, micromirror elements can be generally categorized into three types: electrostatic drive, electromagnetic drive, and piezoelectric drive.

Due to the accessibility of fabrication materials and the maturity of semiconductor process technologies and external assembly techniques, most micromirror elements currently available on the market that are fabricated using semiconductor process technologies adopt electrostatic or electromagnetic driving mechanisms. However, in electrostatic driving, multiple comb electrode structures are used, and due to electrostatic force considerations, the spacing between electrodes cannot be too large, which increases the risk of electrode short-circuiting and the difficulty of fabrication. In electromagnetic driving, coils must be electroplated on top of the micromirror and magnets must be assembled externally. This not only increases the difficulty of miniaturizing the device, but also makes it more difficult to integrate ferromagnetic materials into existing semiconductor processes.

Although piezoelectric driving does not have the drawbacks of high driving voltage and small scanning angle of electrostatic driving, nor high power consumption and Joule heating issues of electromagnetic driving, the piezoelectric materials used in piezoelectric driving inherently exhibit small strain. Therefore, special structural designs are required to amplify the deformation into a torque sufficient to twist the micromirror. However, during the deformation process, it is likely to increase the nonlinearity in the oscillation of the micromirror, thereby degrading the image quality of the projection system.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the present invention was acknowledged by a person of ordinary skill in the art.

### SUMMARY

The present invention provides a projection system and a signal compensation method thereof, in which the oscillation of the rotating member of the piezoelectric actuator exhibits improved linearity, and the driving signal is capable of adaptively compensating for external disturbances.

Other objects and advantages of the present invention may be further understood from the technical features disclosed herein.

To achieve one, part, or all of the aforementioned objectives, or other objectives, an embodiment of the present invention provides a projection system. The projection system includes a light source, at least one piezoelectric actuator, and a control unit. The light source is adapted to provide a light beam. The at least one piezoelectric actuator is adapted to project the light beam from the light source onto a target surface. Each of the at least one piezoelectric actuator comprises a frame, a rotating member, a first actuation structure, a second actuation structure, a sensing structure, a plurality of first transmission members and a plurality of second transmission members. The rotating member is disposed in an opening of the frame and extends along an axial direction to form a rotating shaft structure. The rotating shaft structure has an axis extending in the axial direction. The rotating member is adapted to reciprocally oscillate relative to the frame about the axis. The first actuation structure is disposed between the frame and the rotating member and is connected to the frame. The second actuation structure is disposed in the opening. The second actuation structure is located on opposite sides of the rotating member along the axial direction and is connected to the rotating member via the rotating shaft structure. The sensing structure is disposed between the frame and the rotating member and is connected to the frame. The first actuation structure and the sensing structure are symmetrically arranged on opposite sides of the axis of the rotating shaft structure. The plurality of first transmission members connect the first actuation structure to the second actuation structure. The first actuation structure is coupled to the rotating member via the second actuation structure and the plurality of first transmission members. The plurality of second transmission members connect the second actuation structure to the sensing structure. The sensing structure is coupled to the rotating member via the second actuation structure and the plurality of second transmission members. The at least one piezoelectric actuator includes a first piezoelectric actuator. The first actuation structure and the second actuation structure of the first piezoelectric actuator receive a first driving signal and undergo deformation to drive oscillation of the rotating member of the first piezoelectric actuator, such that the light beam scans along a motion trajectory on the target surface. The rotating member in oscillation of the first piezoelectric actuator actuates the sensing structure of the first piezoelectric actuator via the second actuation structure and the second transmission members of the first piezoelectric actuator, so that the sensing structure of the first piezoelectric actuator undergoes corresponding deformation and generates a first sensing signal. The first driving signal satisfies the following equation: V₁=A₁sin(ω₁t+φ₁), and the first sensing signal satisfies the following equation: V₁″=A₁″sin(ω₁t+φ₁+δ₁), wherein V₁ is the first driving signal, A₁ is a first driving amplitude, ω₁ is a first frequency, φ₁ is a first phase, t is time, V₁″ is [symbol] sensing signal, A₁″ is a first sensing amplitude, and δ₁ is a first phase variation. The control unit is electrically coupled to the at least one piezoelectric actuator and the light source. The control unit is adapted to adjust the first driving amplitude A₁ of the first driving signal V₁ based on the first sensing amplitude A₁″ of the first sensing signal V₁″, and/or to adjust the first phase of the first driving signal V₁ from φ₁ to φ₁+δ₁ based on the first phase variation δ₁ of the first sensing signal V₁″.

In an embodiment of the present invention, the at least one piezoelectric actuator of the projection system further includes a second piezoelectric actuator. The first actuation structure and the second actuation structure of the second piezoelectric actuator receive a second driving signal and undergo deformation to drive oscillation of the rotating member of the second piezoelectric actuator, such that the light beam scans along the motion trajectory on the target surface. The rotating member in oscillation of the second piezoelectric actuator actuates the sensing structure of the second piezoelectric actuator via the second actuation structure and the plurality of second transmission members of the second piezoelectric actuator, so that the sensing structure of the second piezoelectric actuator undergoes corresponding deformation and generates a second sensing signal. The second driving signal satisfies the following equation: V₂=A₂sin(ω₂t+φ₂), and the second sensing signal satisfies the following equation: V₂″=A₂″sin(ω₂t+φ₂+δ₂), wherein V₂ is the second driving signal, A₂ is a second driving amplitude, ω₂ is a second frequency, φ₂ is a second phase, V₂″ is the second sensing signal, A₂″ is a second sensing amplitude, and δ₂ is a second phase variation. The control unit is further adapted to adjust the second driving amplitude A₂ of the second driving signal V₂ based on the second sensing amplitude A₂″ of the second sensing signal V₂″, and/or to adjust the second phase of the second driving signal V₂ from φ₂ to φ₂+δ₂ based on the second phase variation δ₂ of the second sensing signal V₂″.

In an embodiment of the present invention, the projection system further includes driving circuit and a sensing circuit. The driving circuit is electrically coupled to the control unit and to the first actuation structure and the second actuation structure of each of the first piezoelectric actuator and the second piezoelectric actuator. The driving circuit outputs the first driving signal and the second driving signal to the first piezoelectric actuator and the second piezoelectric actuator, respectively, based on the first driving amplitude, the first phase, the second driving amplitude and the second phase provided by the control unit. The sensing circuit is electrically coupled to the control unit and to the sensing structure of each of the first piezoelectric actuator and the second piezoelectric actuator. The first sensing signal and the second sensing signal are processed by the sensing circuit and then output to the control unit.

In an embodiment of the present invention, the control unit of the projection system is adapted to calculate equations of motion, expressed as: D₁=B₁sin(ω₁t+φ₁+δ₁) and D₂=B₂sin(ω₂t+φ₂+δ₂), for the motion trajectory based on the first driving signal and the second driving signal, wherein D₁ represents a displacement of the light beam on the target surface along a first scanning direction, D₂ represents a displacement of the light beam on the target surface along a second scanning direction, B₁ represents a maximum displacement of the motion trajectory along the first scanning direction, B₂ represents a maximum displacement of the motion trajectory along the second scanning direction, and the first scanning direction is perpendicular to the second scanning direction.

In an embodiment of the present invention, the control unit of the projection system is further adapted to respectively construct a scanning matrix and an image matrix based on the equations of motion and an input image, and to output a light source control signal based on a comparison result between the scanning matrix and the image matrix.

In an embodiment of the present invention, the projection system further includes a driving circuit and a light source driving unit. The driving circuit is electrically coupled to the control unit and to the first actuation structure and the second actuation structure of each of the first piezoelectric actuator and the second piezoelectric actuator. The driving circuit outputs the first driving signal and the second driving signal to the first piezoelectric actuator and the second piezoelectric actuator, respectively, based on the first driving amplitude, the first phase, the second driving amplitude, and the second phase provided by the control unit. The light source driving unit is electrically coupled to the light source and the control unit. The light source driving unit receives the light source control signal from the control unit and outputs a switching signal to the light source.

In an embodiment of the present invention, the light source driving unit and the driving circuit of the projection system receive a clock signal to synchronize the first driving signal, the second driving signal, and the switching signal.

In an embodiment of the present invention, each of the at least one piezoelectric actuator of the projection system further includes an elastic member connected between the frame and the second actuation structure along the axis of the rotating shaft structure.

In an embodiment of the present invention, the control unit of the projection system is adapted to calculate an equation of motion, expressed as: D₁=B₁sin(ω₁t+φ₁+δ₁), for the motion trajectory based on the first driving signal, wherein D₁ represents a displacement of the light beam on the target surface along a first scanning direction, and B₁ represents a maximum displacement of the motion trajectory along the first scanning direction.

To achieve one, part, or all of the aforementioned objectives, or other objectives, an embodiment of the present invention provides a signal compensation method of a projection system. The projection system includes a light source and at least one piezoelectric actuator. The light source is adapted to provide a light beam. The at least one piezoelectric actuator is adapted to project the light beam onto a target surface and scan along a motion trajectory. Each of the at least one piezoelectric actuator includes a frame, a rotating member, a first actuation structure, a second actuation structure and a sensing structure. The first actuation structure and the sensing structure are coupled to the rotating member via the second actuation structure and connected to the frame. The signal compensation method of the projection system includes inputting a first driving signal to the first actuation structure and the second actuation structure of a first piezoelectric actuator of the at least one piezoelectric actuator, such that the first actuation structure and the second actuation structure of the first piezoelectric actuator undergo deformation and drive oscillation of the rotating member of the first piezoelectric actuator. The rotating member in oscillation of the first piezoelectric actuator actuates the sensing structure of the first piezoelectric actuator via the second actuation structure of the first piezoelectric actuator, so that the sensing structure of the first piezoelectric actuator undergoes corresponding deformation and generates a first sensing signal. The first driving signal satisfies the following equation: V₁=A₁sin(ω₁t+φ₁), and the first sensing signal satisfies the following equation: V₁″=A₁″sin(ω₁t+φ₁+δ₁), wherein V₁ is the first driving signal, A₁ is a first driving amplitude, ω₁ is a first frequency, φ₁ is a first phase, t is time, V₁″ is the first sensing signal, A₁″ is a first sensing amplitude, and δ₁ is a first phase variation. The signal compensation method of the projection system further includes adjusting the first driving amplitude A₁ of the first driving signal V₁ based on the first sensing amplitude A₁″ of the first sensing signal V₁″, and/or adjusting the first phase of the first driving signal V₁ from φ₁ to φ₁+δ₁ based on the first phase variation δ₁ of the first sensing signal V₁″.

In an embodiment of the present invention, the projection system of the signal compensation method of the projection system further includes a light source and at least one piezoelectric actuator. The light source is configured to provide a light beam. The at least one piezoelectric actuator projects the light beam onto a target surface, and scans along a motion trajectory. Each of the at least one piezoelectric actuator includes a frame, a rotating member, a first actuation structure, a second actuation structure and a sensing structure. The first actuation structure and the sensing structure are each coupled to the rotating member via the second actuation structure and connected to the frame. The signal compensation method of the projection system includes inputting a first driving signal to the first actuation structure and the second actuation structure of a first piezoelectric actuator of the at least one piezoelectric actuator, such that the first actuation structure and the second actuation structure of the first piezoelectric actuator undergo deformation and drive oscillation of the rotating member of the first piezoelectric actuator. The rotating member in oscillation of the first piezoelectric actuator actuates the sensing structure of the first piezoelectric actuator via the second actuation structure of the first piezoelectric actuator, so that the sensing structure of the first piezoelectric actuator undergoes corresponding deformation and generates a first sensing signal. The first driving signal satisfies the following equation: V₁=A₁sin(ω₁t+φ₁), and the first sensing signal satisfies the following equation: V₁″=A₁″sin(ω₁t+φ₁+δ₁), wherein V₁ is the first driving signal, A₁ is a first driving amplitude, ω₁ is a first frequency, φ₁ is a first phase, t is time, V₁″ is [symbol] sensing signal, A₁″ is a first sensing amplitude, and δ₁ is a first phase variation. The signal compensation method of the projection system further includes adjusting the first driving amplitude A₁ of the first driving signal V₁ based on the first sensing amplitude A₁″ of the first sensing signal V₁″, and/or adjusting the first phase of the first driving signal V₁ from φ₁ to φ₁+δ₁ based on the first phase variation δ₁ of the first sensing signal V₁″.

In an embodiment of the present invention, the signal compensation method of the projection system further includes inputting a second driving signal to the first actuation structure and the second actuation structure of a second piezoelectric actuator of the at least one piezoelectric actuator, such that the first actuation structure and the second actuation structure of the second piezoelectric actuator undergo deformation and drive oscillation of the rotating member of the second piezoelectric actuator. The rotating member in oscillation of the second piezoelectric actuator actuates the sensing structure of the second piezoelectric actuator via the second actuation structure of the second piezoelectric actuator, so that the sensing structure of the second piezoelectric actuator undergoes corresponding deformation and generates a second sensing signal. The second driving signal satisfies the following equation: V₂=A₂sin(ω₂t+φ₂), and the second sensing signal satisfies the following equation: V₂″=A₂″sin(ω₂t+φ₂+δ₂), wherein V₂ is the second driving signal, A₂ is a second driving amplitude, ω₂ is a second frequency, φ₂ is a second phase, V₂″ is the second sensing signal, A₂″ is a second sensing amplitude, and δ₂ is a second phase variation. The signal compensation method of the projection system further comprises adjusting the second driving amplitude A₂ of the second driving signal V₂ based on the second sensing amplitude A₂″ of the second sensing signal V₂″, and/or adjusting the second phase of the second driving signal V₂ from φ₂ to φ₂+δ₂ based on the second phase variation δ₂ of the second sensing signal V₂″.

In an embodiment of the present invention, the signal compensation method of the projection system further includes calculating equations of motion, expressed as: D₁=B₁sin(ω₁t+φ₁+δ₁) and D₂=B₂sin(ω₂t+φ₂+δ₂), for the motion trajectory based on the first driving signal and the second driving signal, wherein D₁ represents a displacement of the light beam on the target surface along a first scanning direction, D₂ represents a displacement of the light beam on the target surface along a second scanning direction, B₁ represents a maximum displacement of the motion trajectory along the first scanning direction, and B₂ represents a maximum displacement of the motion trajectory along the second scanning direction. The first scanning direction is perpendicular to the second scanning direction.

In an embodiment of the present invention, the signal compensation method of the projection system further includes constructing a scanning matrix and an image matrix respectively based on the equations of motion and an image to be projected, and outputting a light source control signal based on a comparison result between the scanning matrix and the image matrix.

In an embodiment of the present invention, the signal compensation method of the projection system further includes outputting a switching signal to the light source based on the light source control signal. The light source is switched on or off according to the switching signal as the light beam scans along the motion trajectory on the target surface.

In an embodiment of the present invention, the signal compensation method of the projection system further includes synchronizing the switching signal, the first driving signal and the second driving signal based on a clock signal before the switching signal is output to the light source.

Based on the above, in the projection system according to an embodiment of the present invention, the configuration of the plurality of first transmission members connecting the first actuation structure and the second actuation structure, and the plurality of second transmission members connecting the second actuation structure and the sensing structure can significantly reduce the nonlinearity in the oscillation of the rotating member of the piezoelectric actuator, thereby improving the sharpness of the projected image of the projection system. In addition, the first actuation structure, which is connected between the second actuation structure and the frame, not only serves a fixing function but also provides additional linear actuation force. The linear actuation force, using the second actuation structure as a lever arm, generates additional torque to twist the rotating member, thereby achieving a greater rotation angle. In the signal compensation method of the projection system according to an embodiment of the present invention, the control unit adjusts the driving amplitude of the driving signal based on the sensing amplitude of the sensing signal, and/or adjusts the phase of the driving signal based on the phase variation of the sensing signal, so as to compensate for the influence of external disturbances on the piezoelectric actuator and thereby maintain the display quality of the projected image.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram of a projection system according to an embodiment of the present invention.

FIG. 2 is a schematic top view of the piezoelectric actuator of FIG. 1.

FIG. 3 is a perspective schematic diagram of the piezoelectric actuator of FIG. 1.

FIG. 4 is schematic a cross-sectional view of the piezoelectric actuator of FIG. 2.

FIG. 5 is a partially enlarged schematic diagram of the piezoelectric actuator of FIG. 2.

FIG. 6 is a schematic cross-sectional view of the piezoelectric actuator of FIG. 5.

FIG. 7 is another partially enlarged schematic diagram of the piezoelectric actuator of FIG. 2.

FIG. 8 is a schematic diagram illustrating the reciprocating oscillation of the rotating member about the axis in the piezoelectric actuator of FIG. 3.

FIG. 9 is a distribution diagram of the rotation angle of the rotating member versus the driving voltage after the piezoelectric actuator of FIG. 2 receives the driving signal.

FIG. 10 is a distribution diagram of the sensing voltage generated by the piezoelectric actuator of FIG. 2 versus the rotation angle of its rotating member.

FIG. 11 is a distribution diagram of the phase variation of mechanical vibration caused by simulated external disturbances, relative to the driving signal, plotted against the driving voltage.

FIG. 12 is a distribution diagram of the phase variation of mechanical vibration caused by simulated external disturbances, relative to the sensing signal, plotted against the driving voltage.

FIG. 13 is a block diagram of the projection system of FIG. 1.

FIGS. 14A to 14C are flowcharts of a signal compensation method of the projection system of FIG. 1.

FIG. 15 is a flowchart of a modified embodiment of the method step of FIG. 14A.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

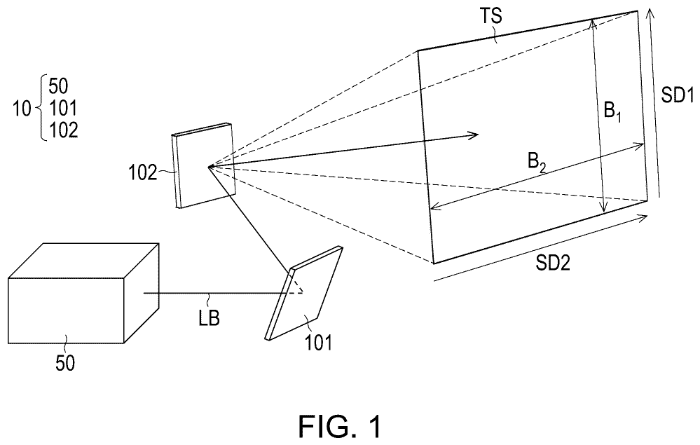

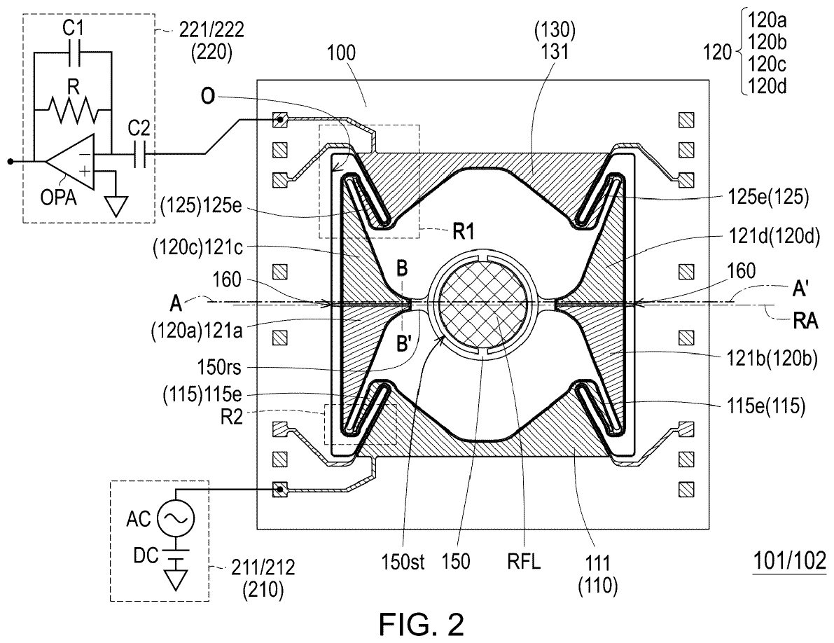

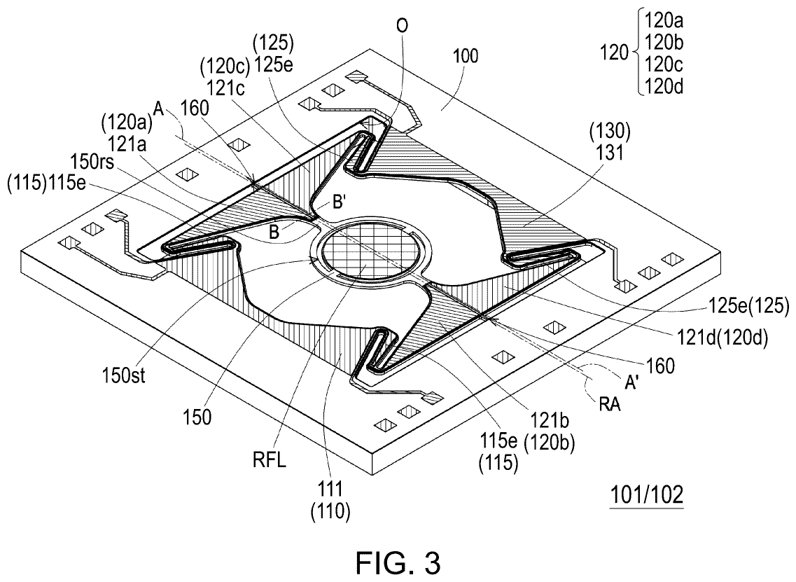

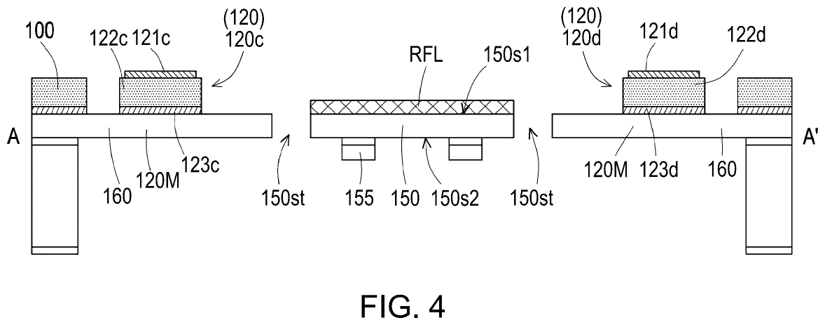

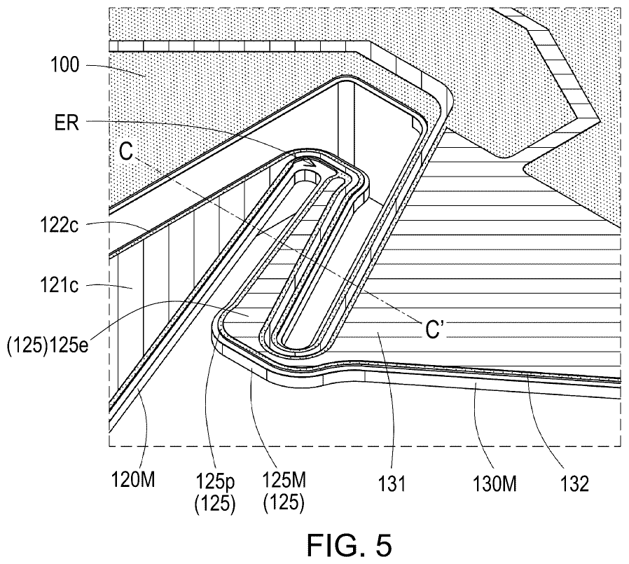

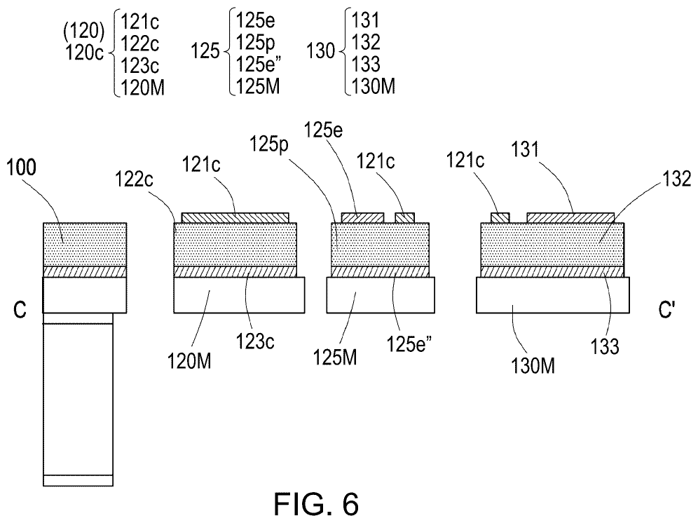

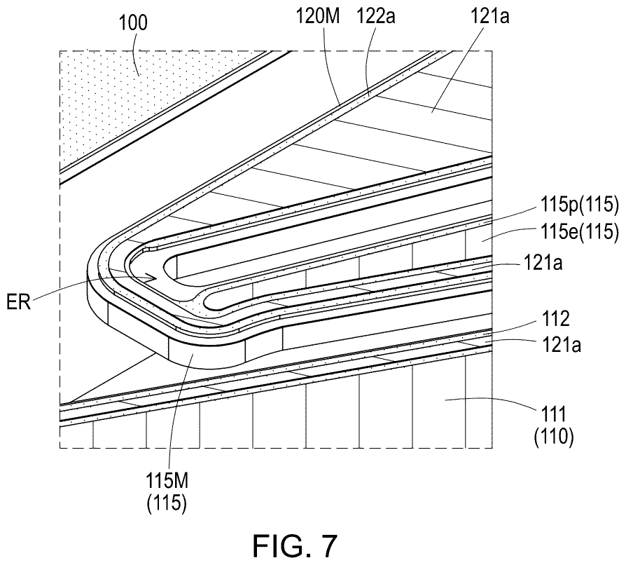

FIG. 1 is a schematic diagram of a projection system according to an embodiment of the present invention. FIG. 2 is a schematic top view of the piezoelectric actuator of FIG. 1. FIG. 3 is a perspective schematic diagram of the piezoelectric actuator of FIG. 1. FIG. 4 is schematic a cross-sectional view of the piezoelectric actuator of FIG. 2. FIG. 5 is a partially enlarged schematic diagram of the piezoelectric actuator of FIG. 2. FIG. 6 is a schematic cross-sectional view of the piezoelectric actuator of FIG. 5. FIG. 7 is another partially enlarged schematic diagram of the piezoelectric actuator of FIG. 2. FIG. 8 is a schematic diagram illustrating the reciprocating oscillation of the rotating member about the axis in the piezoelectric actuator of FIG. 3. FIG. 4 corresponds to the section line A-A′ in FIG. 3. FIG. 5 corresponds to the region R1 in FIG. 2. FIG. 6 corresponds to the section line C-C′ in FIG. 5. FIG. 7 corresponds to the region R2 in FIG. 2.

Referring to FIGS. 1 and 2, a projection system 10 includes a light source 50, a piezoelectric actuator 101, and a piezoelectric actuator 102. The light source 50 is adapted to provide a light beam LB. The light source 50 may include, for example, a plurality of laser diodes or light-emitting diodes with different emission colors (e.g., red, green, and blue), but the present invention is not limited thereto. The piezoelectric actuator 101 and the piezoelectric actuator 102 are disposed on a transmission path of the light beam LB from the light source 50 and are adapted to project the light beam LB onto a target surface TS.

For example, in the embodiment, the piezoelectric actuator 101 is adapted to move the light beam LB along a scanning direction SD1 on the target surface TS, while the piezoelectric actuator 102 is adapted to move the light beam LB along a scanning direction SD2 on the target surface TS, wherein the scanning direction SD1 is different from the scanning direction SD2. In th embodiment, the scanning direction SD1 is perpendicular to the scanning direction SD2. However, the present invention is not limited thereto. In one embodiment, the projection system may include only one piezoelectric actuator, which is adapted to move the light beam LB along any direction on the target surface TS.

Referring to FIGS. 2 and 3, in detail, each of the piezoelectric actuator 101 and the piezoelectric actuator 102 includes a frame 100, a first actuation structure 110, a second actuation structure 120, a sensing structure 130, a rotating member 150, a plurality of first transmission members 115, and a plurality of second transmission members 125. The frame 100 has an opening O. The rotating member 150 is disposed in the opening O and extends along an axial direction of an axis RA to form a rotating shaft structure 150rs. The rotating member 150 is coupled to the frame 100 via the rotating shaft structure 150rs, and is adapted to reciprocally oscillate relative to the frame 100 about the axis RA (as shown in FIG. 8).

The first actuation structure 110 is disposed between the frame 100 and the rotating member 150, and is connected to the frame 100. The second actuation structure 120 is disposed in the opening O and is located on opposite sides of the rotating member 150 along the axial direction of the axis RA. The second actuation structure 120 is connected to the rotating member 150 via the rotating shaft structure 150rs. The sensing structure 130 is disposed between the frame 100 and the rotating member 150, and is connected to the frame 100. In the embodiment, the first actuation structure 110 and the sensing structure 130 are symmetrically disposed on opposite sides of the axis RA of the rotating shaft structure 150rs, and the second actuation structure 120 is symmetrically disposed around the axis RA of the rotating shaft structure 150rs and alongside the rotating shaft structure 150rs. Accordingly, the piezoelectric actuator can operate more stably. More specifically, the first actuation structure 110, the second actuation structure 120, and the sensing structure 130 are disposed around the rotating member 150.

In the embodiment, the second actuation structure 120 may include four sub-actuators, namely a sub-actuator 120a, a sub-actuator 120b, a sub-actuator 120c, and a sub-actuator 120d. The sub-actuator 120a and the sub-actuator 120c are connected to each other and symmetrically disposed on opposite sides of the axis RA of the rotating shaft structure 150rs. Similarly, the sub-actuator 120b and the sub-actuator 120d are connected to each other and symmetrically disposed on opposite sides of the axis RA.

From another perspective, the first actuation structure 110 and the sensing structure 130 extend from side edges of the frame 100 into the opening O of the frame 100. On a reference plane parallel to the rotating member 150 in a stationary state, the projected contour of the first actuation structure 110 and the sensing structure 130 is, for example, flat-concave, wherein the side of each projected contour facing the frame 100 is linear, and the side facing the rotating member 150 is a concave curve. On the other hand, the projected contour of the second actuation structure 120 on the reference plane is substantially triangular.

The plurality of first transmission members 115 connect the first actuation structure 110 and the second actuation structure 120. The first actuation structure 110 is coupled to the rotating member 150 via the second actuation structure 120 and the plurality of first transmission members 115. The plurality of second transmission members 125 connect the second actuation structure 120 and the sensing structure 130. The sensing structure 130 is coupled to the rotating member 150 via the second actuation structure 120 and the plurality of second transmission members 125. In the embodiment, the first transmission members 115 and the second transmission members 125 may be flexible members, and the number of each is two. For example, one of the two first transmission members 115 connects the first actuation structure 110 to the sub-actuator 120a of the second actuation structure 120, and the other connects the first actuation structure 110 to the sub-actuator 120b of the second actuation structure 120. These two first transmission members 115 are used to transmit the actuation force from the first actuation structure 110 to the sub-actuator 120a and the sub-actuator 120b of the second actuation structure 120 to drive the rotating member 150 to oscillate.

On the other hand, one of the two second transmission members 125 connects the sensing structure 130 to the sub-actuator 120c of the second actuation structure 120, and the other connects the sensing structure 130 to the sub-actuator 120d of the second actuation structure 120. The strain force generated by the rotating member 150 in oscillation is transmitted to the sensing structure 130 via the sub-actuators 120c and 120d of the second actuation structure 120 and the two second transmission members 125, thereby causing the sensing structure 130 to deform.

It is particularly noted that, in the embodiment, the first transmission member 115 and the second transmission member 125 each have a projected contour that is substantially S-shaped or bent on the reference plane parallel to the rotating member 150 in the stationary state. At the bent portion of the first transmission member 115 or the second transmission member 125, part of the stress can be converted into structural deformation. Accordingly, stress concentration caused by deformation in the first actuation structure 110, the second actuation structure 120, or the sensing structure 130 can be avoided, thereby reducing the risk of damage to the piezoelectric actuator 101 and the piezoelectric actuator 102. In other words, the two first transmission members 115 and the two second transmission members 125 also serve the function of stress relief.

Furthermore, the first actuation structure 110 and the second actuation structure 120 are each adapted to receive a driving signal, such that the first actuation structure 110 and the second actuation structure 120 are respectively deformed and drive the rotating member 150 to oscillate. For example, when the sub-actuators 120a and 120b of the second actuation structure 120 are each applied with a positive voltage to generate a compressive strain, the two sub-actuators 120a and 120b of the second actuation structure 120 are driven to undergo contraction deformation (e.g., bending upward relative to the frame 100). Meanwhile, the first actuation structure 110 and the two sub-actuators 120c and 120d of the second actuation structure 120 are each applied with a negative voltage to generate a tensile strain, and the first actuation structure 110 and the two sub-actuators 120c and 120d of the second actuation structure 120 are driven to undergo extension deformation (e.g., bending downward relative to the frame 100). At this time, the rotating member 150 is driven to rotate about the axis RA along a rotation direction RD1 by the two sub-actuators 120a and 120b undergoing contraction deformation, as well as the first actuation structure 110 and the two sub-actuators 120c and 120d undergoing extension deformation (as shown in FIG. 8).

Conversely, when the two sub-actuators 120a and 120b of the second actuation structure 120 are each applied with a negative voltage to generate a tensile strain, the two sub-actuators 120a and 120b of the second actuation structure 120 are driven to undergo extension deformation (e.g., bending downward relative to the frame 100). Meanwhile, the first actuation structure 110 and the two sub-actuators 120c and 120d of the second actuation structure 120 are each applied with a positive voltage to generate a compressive strain, and the first actuation structure 110 and the two sub-actuators 120c and 120d of the second actuation structure 120 are driven to undergo contraction deformation (e.g., bending upward relative to the frame 100). At this time, the rotating member 150 is driven to rotate about the axis RA along a rotation direction RD2 by the two sub-actuators 120a and 120b undergoing extension deformation, as well as the first actuation structure 110 and the two sub-actuators 120c and 120d undergoing contraction deformation, wherein the rotation direction RD2 is opposite to the rotation direction RD1.

From another perspective, the two sub-actuators (e.g., sub-actuators 120a and 120b, or sub-actuators 120c and 120d) of the second actuation structure 120 located on the same side of the axis RA of the rotating shaft structure 150rs receive driving signals with the same phase, while the two sub-actuators (e.g., sub-actuators 120a and 120c, or sub-actuators 120b and 120d) of the second actuation structure 120 located on opposite sides of the axis RA receive driving signals with opposite phases. A driving electrode 111 of the first actuation structure 110, and a driving electrode 121c of the sub-actuator 120c and a driving electrode 121d of the sub-actuator 120d of the second actuation structure 120 receive three driving signals with the same phase. That is, the phase of the driving signal received by the driving electrode 111 of the first actuation structure 110 is opposite to the phase of the driving signal received by each of a driving electrode 121a of the sub-actuator 120a and a driving electrode 121b of the sub-actuator 120b of the second actuation structure 120.

On the other hand, the rotating member 150 in oscillation drives the sensing structure 130 to deform and output a corresponding sensing signal. For example, when the rotating member 150 rotates along the rotation direction RD1, the sensing structure 130 is driven to undergo a compressive deformation (e.g., bending upward relative to the frame 100), thereby generating a positive voltage and forming a corresponding sensing signal. Conversely, when the rotating member 150 rotates along the rotation direction RD2, the sensing structure 130 is driven to undergo a tensile deformation (e.g., bending downward relative to the frame 100), thereby generating a negative voltage and forming a corresponding sensing signal.

Furthermore, the first actuation structure 110 and the second actuation structure 120 are each a stacked structure including a driving electrode, a piezoelectric layer, a lower electrode, and a driving body. For example, as shown in FIGS. 2 and 7, the first actuation structure 110 includes the driving electrode 111, a piezoelectric layer 112, a lower electrode (not shown), and a driving body (not shown). Similarly, the first transmission member 115 includes a transmission electrode 115e, a piezoelectric layer 115p, a lower electrode (not shown), and a transmission body 115M. The sub-actuator 120a of the second actuation structure 120 includes the driving electrode 121a, a piezoelectric layer 122a, a lower electrode (not shown), and a driving body 120M. In addition, the sub-actuator 120b of the second actuation structure 120, which is located on the same side of the axis RA of the rotating shaft structure 150rs as the sub-actuator 120a, also includes the driving electrode 121b, a piezoelectric layer (not shown), a lower electrode (not shown), and a driving body (not shown).

As shown in FIGS. 3 and 4, the sub-actuator 120c of the second actuation structure 120 includes the driving electrode 121c, a piezoelectric layer 122c, a lower electrode 123c, and a driving body 120M. The sub-actuator 120d of the second actuation structure 120 includes the driving electrode 121d, a piezoelectric layer 122d, a lower electrode 123d, and a driving body 120M. Similarly, as shown in FIGS. 5 and 6, the second transmission member 125 includes a transmission electrode 125e, a piezoelectric layer 125p, a lower electrode 125e”, and a transmission body 125M. The sensing structure 130 includes a sensing electrode 131, a piezoelectric layer 132, a lower electrode 133, and a sensing body 130M.

In the embodiment, the driving bodies of the four sub-actuators of the first actuation structure 110 and the second actuation structure 120, the sensing body of the sensing structure 130, the transmission body of the first transmission member 115, and the transmission body of the second transmission member 125 may be integrally connected. Similarly, the piezoelectric layers of the first actuation structure 110, the second actuation structure 120, the sensing structure 130, the first transmission member 115, and the second transmission member 125 may be integrally connected. The lower electrodes of the first actuation structure 110, the second actuation structure 120, the sensing structure 130, the first transmission member 115, and the second transmission member 125 may be integrally connected.

It is particularly noted that, as shown in FIGS. 2 and 7, the transmission electrode 115e of the first transmission member 115 extends from the driving electrode 111 of the first actuation structure 110, i.e., the transmission electrode 115e and the driving electrode 111 are formed integrally. Each of the driving electrode 121a of the sub-actuator 120a and the driving electrode 121b of the sub-actuator 120b of the second actuation structure 120 extends on the transmission body 115M of the adjacent first transmission member 115 and the driving body of the first actuation structure 110 to be connected to a circuit contact on the frame 100. Similarly, as shown in FIGS. 2 and 5, the transmission electrode 125e of the second transmission member 125 extends from the sensing electrode 131 of the sensing structure 130, i.e., the transmission electrode 125e and the sensing electrode 131 are formed integrally. Each of the driving electrode 121c of the sub-actuator 120c and the driving electrode 121d of the sub-actuator 120d of the second actuation structure 120 extends on the transmission body 125M of the adjacent second transmission member 125 and the sensing body 130M of the sensing structure 130 to be connected to a circuit contact on the frame 100.

More specifically, the driving electrode 111 of the first actuation structure 110, the driving electrodes 121a, 121b, 121c, and 121d of the sub-actuators 120a, 120b, 120c, and 120d of the second actuation structure 120, and the sensing electrode 131 of the sensing structure 130 are electrically independent from each other.

In the embodiment, the first actuation structure 110 is configured to generate a linear actuation force, and the second actuation structure 120 is configured to generate a torque actuation force. The actuation force generated when the first actuation structure 110 is driven is perpendicular to the reference plane parallel to the rotating member 150 in the stationary state and generates torque using the second actuation structure 120 as a lever arm to drive the rotating member 150 to oscillate. It is particularly noted that, in addition to serving as a lever arm when the first actuation structure 110 operates, the second actuation structure 120 itself can also be driven to generate torque. More specifically, when the second actuation structure 120 is driven to generate torque, the actuation force generated by the first actuation structure 110 can be transmitted via the two first transmission members 115 to further amplify the torque applied by the second actuation structure 120 to the rotating member 150. In other words, through the cooperative relationship between the first actuation structure 110 and the second actuation structure 120, the rotating member 150 of each of the piezoelectric actuator 101 and the piezoelectric actuator 102 can achieve a larger rotation angle.

Furthermore, as shown in FIGS. 3 and 4, each of the piezoelectric actuator 101 and the piezoelectric actuator 102 further includes a reflective layer RFL, disposed on a first surface 150s1 of the rotating member 150. The reflective layer RFL may be, for example, a metal reflective layer or a reflective mirror. To enhance the rigidity of the rotating member 150, a reinforcement structure 155 may be disposed on a second surface 150s2 of the rotating member 150, wherein the second surface 150s2 faces away from the first surface 150s1. On the other hand, as shown in FIGS. 3 and 8, the rotating member 150 may be provided with two slots 150st, which generally surround the reflective layer RFL. The slots 150st may be through holes penetrating the rotating member 150 or grooves recessed from the surface of the rotating member 150. It is particularly noted that the axis RA of the rotating shaft structure 150rs passes through the two slots 150st. Accordingly, the torsional stress generated at the connection between the rotating shaft structure 150rs and the frame 100 due to the oscillation of the rotating member 150 can be released.

In the embodiment, each of the piezoelectric actuator 101 and the piezoelectric actuator 102 further includes two elastic members 160. These two elastic members 160 are disposed between the frame 100 and the second actuation structure 120 along the axis RA of the rotating shaft structure 150rs. More specifically, these two elastic members 160 are respectively located on opposite sides of the rotating member 150. The sub-actuators 120a and 120c of the second actuation structure 120 may be connected to the frame 100 via one of the elastic members 160, and the sub-actuators 120b and 120d of the second actuation structure 120 may be connected to the frame 100 via the other elastic member 160. The elastic members 160 are configured to limit the amount of deformation of at least one of the first actuation structure 110, the second actuation structure 120, the sensing structure 130, the plurality of first transmission members 115, and the plurality of second transmission members 125, so as to prevent the piezoelectric actuator 101 and the piezoelectric actuator 102 from being damaged by excessive deformation or actuation force.

Referring to FIGS. 5 and 7, a blank region ER may be provided at the connection between the first transmission member 115 and the second actuation structure 120, and another blank region ER may be provided at the connection between the second transmission member 125 and the second actuation structure 120, wherein the blank region ER is a region where no electrode or piezoelectric layer is disposed. Since the connection between the second actuation structure 120 and each of the first transmission member 115 and the second transmission member 125 is prone to become a major stress concentration point during overall deformation, and piezoelectric materials are brittle and cannot withstand excessive stress, providing the blank region ER at the connection between the second actuation structure 120 and each of the first transmission member 115 and the second transmission member 125 can significantly reduce the risk of damage to the piezoelectric actuator 101 and the piezoelectric actuator 102.

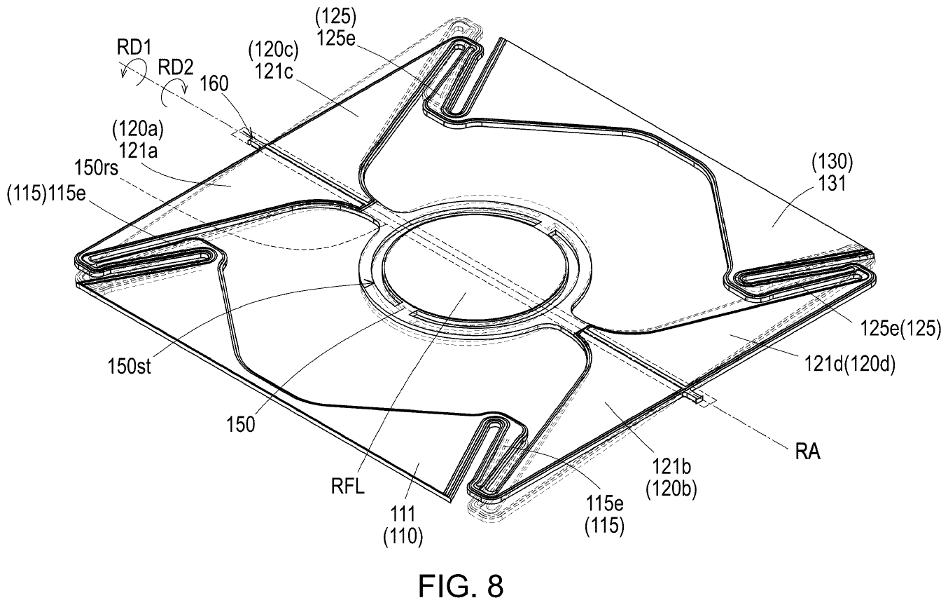

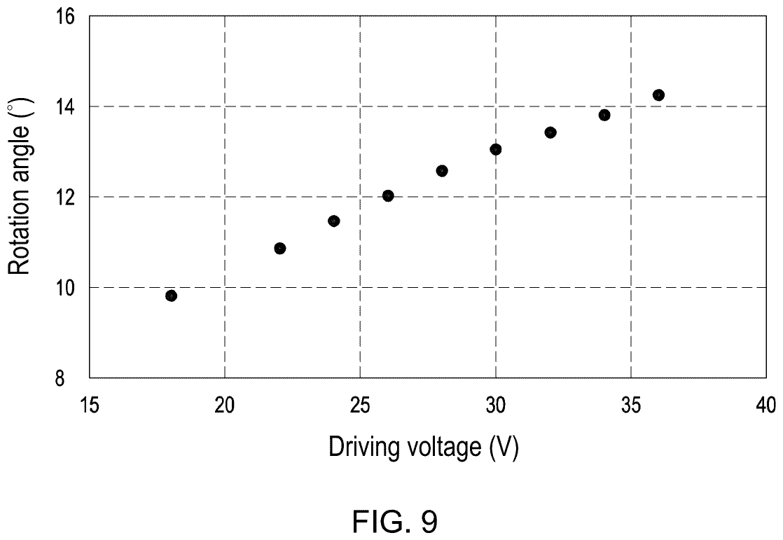

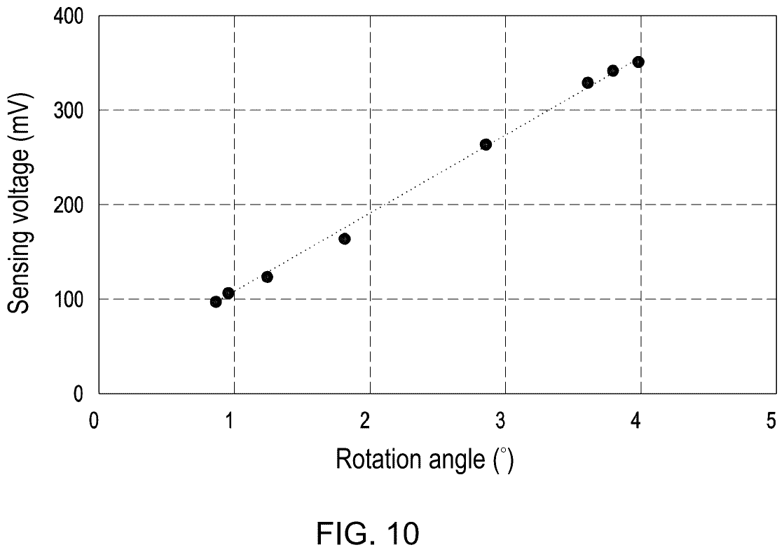

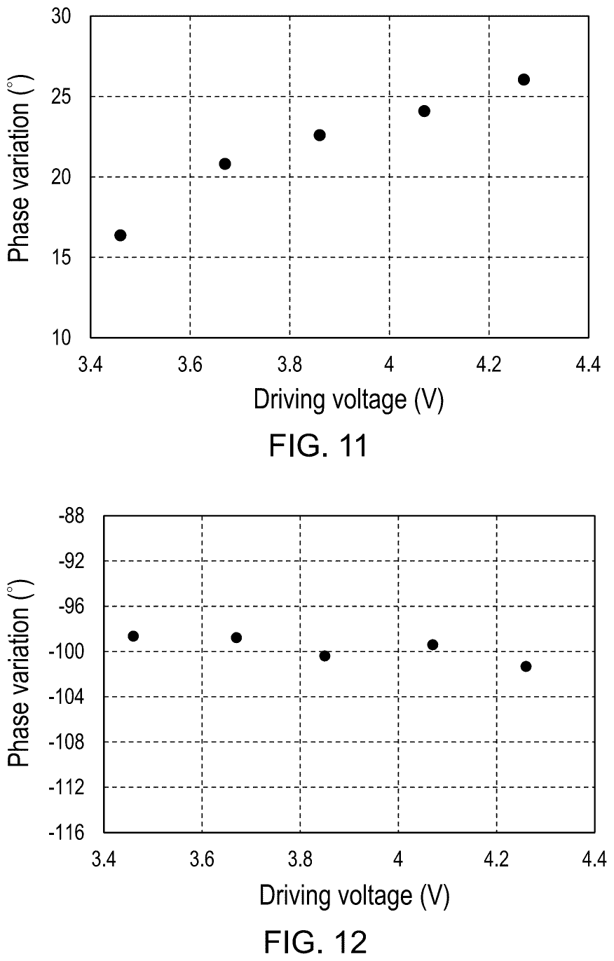

FIG. 9 is a distribution diagram of the rotation angle of the rotating member versus the driving voltage after the piezoelectric actuator of FIG. 2 receives the driving signal. FIG. 10 is a distribution diagram of the sensing voltage generated by the piezoelectric actuator of FIG. 2 versus the rotation angle of its rotating member. FIG. 11 is a distribution diagram of the phase variation of mechanical vibration caused by simulated external disturbances, relative to the driving signal, plotted against the driving voltage. FIG. 12 is a distribution diagram of the phase variation of mechanical vibration caused by simulated external disturbances, relative to the sensing signal, plotted against the driving voltage.

Referring to FIGS. 2 and 9, a good linear relationship exists between the rotation angle of the rotating member 150 and the driving voltage. Therefore, the rotation angle of the rotating member 150 of the piezoelectric actuator in the embodiment can be well controlled. Referring to FIGS. 2 and 10, a good linear relationship also exists between the sensing voltage generated by the sensing structure 130 and the rotation angle of the rotating member 150. Accordingly, the sensing signal output from the piezoelectric actuator of the embodiment can more truly reflect the degree of rotation of the rotating member 150. In addition, as shown in FIG. 10, the slope of the linear relationship between the sensing voltage and the rotation angle can reach 83 mV/deg, indicating that the piezoelectric actuator of the embodiment can have improved sensing capability.

Since the deformation amount of the piezoelectric material used in the piezoelectric actuator is relatively small, a special structural design is required to amplify the deformation into a torque sufficient to twist the rotating member 150. However, such structural design tends to endure excessive stress that cannot be released during the deformation process, thereby increasing the nonlinearity of the oscillation of the rotating member 150. Referring to FIGS. 2 and 11, when the frequency of the driving signal of the piezoelectric actuator falls within a nonlinear region, the phase variation of the resulting mechanical vibration relative to the driving signal increases with the driving voltage. In other words, the mechanical vibration caused by external disturbances can be simulated by operating the piezoelectric actuator within the nonlinear region.

Referring to FIGS. 2 and 12, when the piezoelectric actuator operates within the nonlinear region, the phase variation of mechanical vibration caused by simulated external disturbances relative to the sensing signal remains approximately constant as the driving voltage increases. In other words, the sensing structure 130 of the piezoelectric actuator of the embodiment is capable of truly reflecting the nonlinearity of the mechanical vibration through the sensing signal generated in response to the nonlinear mechanical vibration.

Referring to FIGS. 1, 2, and 3, in the projection system 10, the light beam LB emitted from the light source 50 is projected onto the target surface TS after being reflected by the reflective layer RFL on the rotating member 150 of each of the piezoelectric actuator 101 and the piezoelectric actuator 102. The reciprocating oscillation of the rotating member 150 allows the light beam LB projected onto the target surface TS to scan along a predetermined motion trajectory. For example, in the embodiment, the piezoelectric actuator 101 is adapted to move the light beam LB on the target surface TS along the scanning direction SD1, while the piezoelectric actuator 102 is adapted to move the light beam LB on the target surface TS along the scanning direction SD2. That is, the rotation angle range of the rotating member 150 of the piezoelectric actuator defines the scanning range (i.e., the visible area of the projected image) of the projection system 10 on the target surface TS. The frequency (i.e., the oscillation frequency of the rotating member 150) of the driving signal of the piezoelectric actuator determines the filling rate of the motion trajectory of the light beam LB within the scanning range on the target surface TS. A higher oscillation frequency achieves a higher filling rate, thereby forming a projected image with higher resolution.

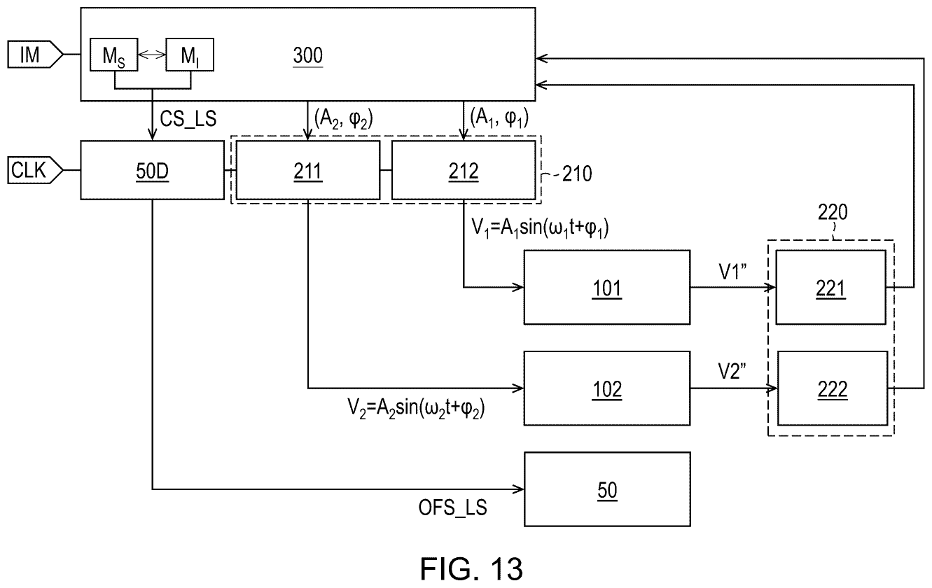

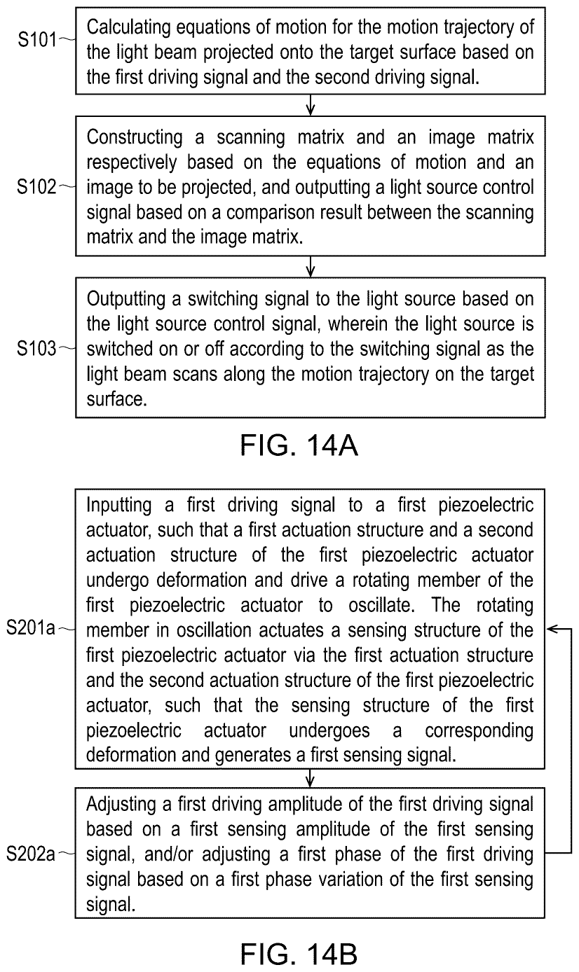

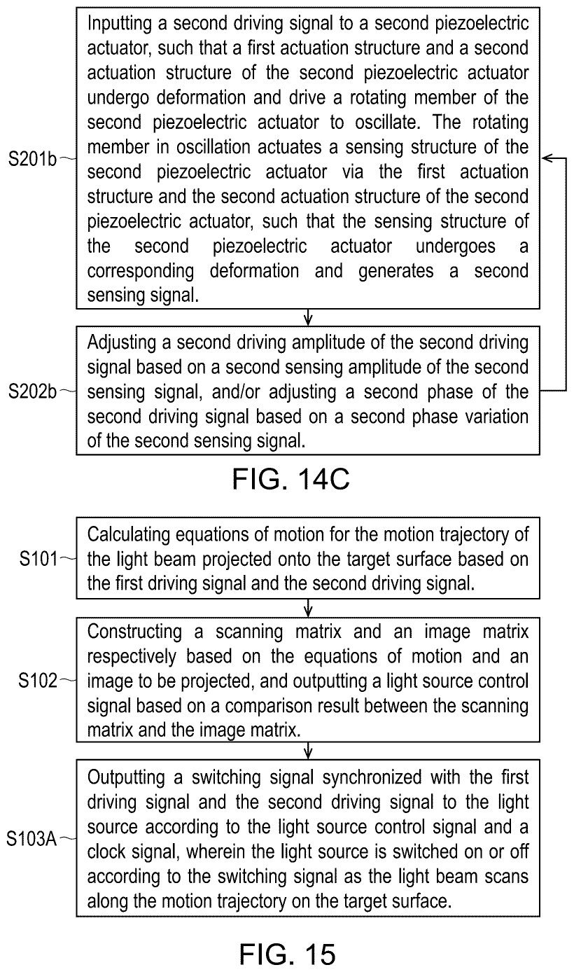

FIG. 13 is a block diagram of the projection system of FIG. 1. FIGS. 14A to 14C are flowcharts of a signal compensation method of the projection system of FIG. 1. FIG. 15 is a flowchart of a modified embodiment of the method step of FIG. 14A.

Referring to FIGS. 1, 2, and 13, the projection system 10 further includes a driving circuit 210, a sensing circuit 220, and a control unit 300. The driving circuit 210 is electrically coupled to the control unit 300 and to the first actuation structure 110 and second actuation structure 120 of each of the piezoelectric actuator 101 and the piezoelectric actuator 102. The sensing circuit 220 is electrically coupled to the control unit 300 and to the sensing structure 130 of each of the piezoelectric actuator 101 and the piezoelectric actuator 102. The control unit 300 is electrically coupled to the piezoelectric actuator 101, the piezoelectric actuator 102 and the light source 50.

For example, in the embodiment, the driving circuit 210 may include a driving unit 211 and a driving unit 212. Each of the driving unit 211 and the driving unit 212 is provided with an alternating current (AC) power supply AC and a direct current (DC) power supply DC. One end of the alternating current power supply AC is coupled to the driving electrode 111 of the first actuation structure 110, and the other end is coupled to one end of the direct current power supply DC, while the other end of the direct current power supply DC is grounded. In other words, the driving signal from the driving unit may be an AC voltage signal with a DC offset, but the present invention is not limited thereto. The driving circuit 210 may further include eight driving units (not shown) of the eight sub-actuators of the two second actuation structures 120 electrically coupled to the two piezoelectric actuators 101 and 102, respectively. The configuration of each of these eight driving units is similar to that of the driving unit 211 and the driving unit 212, and thus will not be described redundantly herein.

The driving circuit 210 outputs a first driving signal V₁ and a second driving signal V₂ to the piezoelectric actuator 101 and the piezoelectric actuator 102, respectively, according to a first driving amplitude A₁, a first phase φ₁, a second driving amplitude A₂, and a second phase φ₂ provided by the control unit 300. In the embodiment, the first driving signal V₁ satisfies the following equation: V₁=A₁sin(ω₁t+φ₁), and the second driving signal V₂ satisfies the following equation: V₂=A₂sin(ω₂t+φ₂), wherein ω₁ is a first frequency, ω₂ is a second frequency, and t is time. That i s, both the first driving signal V₁ and the second driving signal V₂ are sinusoidal waves.

On the other hand, the sensing circuit 220 may include a sensing unit 221 and a sensing unit 222. The sensing unit 221 and the sensing unit 222 are each provided with an amplification circuit, which may include an operational amplifier OPA, a capacitor C1, a capacitor C2, and a resistor R. The capacitor C1 and the resistor R are connected in parallel, and coupled between an inverting input terminal and an output terminal of the operational amplifier OPA. A non-inverting input terminal of the operational amplifier OPA is grounded. The capacitor C2 is connected between the inverting input terminal of the operational amplifier OPA and the sensing electrode 131 of the sensing structure 130. More specifically, in the embodiment, the amplification circuit is, for example, a charge amplifier configured to convert an AC current signal into an AC voltage signal, but the present invention is not limited thereto. The sensing signal generated by the sensing structures 130 of each of the piezoelectric actuator 101 and the piezoelectric actuator 102 is processed by the sensing circuit 220 and then output to the control unit 300. It is first noted that the sensing signals processed by the sensing circuit 220 may serve as feedback signals for the control unit 300.

The control unit 300 is adapted to calculate equations of motion for the motion trajectory of the light beam LB projected onto the target surface TS based on the first driving signal V₁ and the second driving signal V₂ (i.e., step S101 in FIG. 14A). The control unit 300 is further adapted to construct a scanning matrix M_{S} and an image matrix M_{I} respectively based on the equations of motion and an image IM (i.e., the image to be projected), and to output a light source control signal CS_LS based on a comparison result between the scanning matrix M_{S} and the image matrix M_{I} (i.e., step S102 in FIG. 14A).

The projection system 10 further includes a light source driving unit 50D electrically coupled to the light source 50 and the control unit 300. The light source driving unit 50D is adapted to output a switching signal OFS_LS to the light source 50 based on the light source control signal CS_LS from the control unit 300 (i.e., step S103 in FIG. 14A). In one embodiment, the light source driving unit 50D is further adapted to output the switching signal OFS_LS synchronized with the first driving signal V₁ and the second driving signal V₂ to the light source 5 0 according to a clock signal CLK (i.e., step S103A in FIG. 15). The light source 50 receives the switching signal OFS_LS and performs synchronized switching while the light beam LB scans along the motion trajectory on the target surface TS, thereby achieving the image display effect.

The following provides an exemplary description of the image projection process and the signal compensation method of the projection system 10. First, inputting a first driving signal V₁ to the piezoelectric actuator 101, such that the first actuation structure 110 and the second actuation structure 120 of the piezoelectric actuator 101 undergo deformation and drive the rotating member 150 of the piezoelectric actuator 101 to oscillate (i.e., the driving portion of step S201a in FIG. 14B), thereby causing the light beam LB to move along a scanning direction SD1 on the target surface TS. Simultaneously, inputting a second driving signal V₂ to the piezoelectric actuator 102, such that the first actuation structure 110 and the second actuation structure 120 of the piezoelectric actuator 102 undergo deformation and drive the rotating member 150 of the piezoelectric actuator 102 to oscillate (i.e., the driving portion of step S201b in FIG. 14C), thereby causing the light beam LB to move along the scanning direction SD2 on the target surface TS. More specifically, the rotating members 150 in oscillation of each of the piezoelectric actuator 101 and the piezoelectric actuator 102 allows the light beam LB to scan along a motion trajectory on the target surface TS. In the embodiment, since both the first driving signal V₁ and the second driving signal V₂ are sinusoidal waves, the scanning trajectory (or motion trajectory) of the light beam LB on the target surface TS forms a Lissajous pattern.

Furthermore, in the driven piezoelectric actuator 101, the rotating member 150 in oscillation actuates the sensing structure 130 via the second actuation structure 120 and the second transmission member 125, such that the sensing structure 130 undergoes a corresponding deformation and generates a first sensing signal V₁″ (i.e., the sensing portion of step S201a in FIG. 14B). Similarly, in the driven piezoelectric actuator 102, the rotating member 150 in oscillation actuates the sensing structure 130 via the second actuation structure 120 and the second transmission member 125, such that the sensing structure 130 undergoes a corresponding deformation and generates a second sensing signal V₂″ (i.e., the sensing portion of step S201b in FIG. 14C). The first sensing signal V₁″ satisfies the following equation: V₁″=A₁″sin(ω₁t+φ₁+δ₁), and the second sensing signal V₂″ satisfies the following equation: V₂″=A₂″sin(ω₂t+φ₂+δ₂), wherein A₁″ is a first sensing amplitude, δ₁ is a first phase variation, A₂″ is a second sensing amplitude, and δ₂ is a second phase variation. The aforementioned sensing amplitude is, for example, the sensing voltage shown in FIG. 10.

It is particularly noted that the aforementioned first phase variation δ₁ and second phase variation δ₂ represent the phase difference or phase delay caused by the inherent nonlinearity (e.g., stress concentration during structural deformation) of the piezoelectric actuator 101 and the piezoelectric actuator 102 during operation, and by external disturbances (e.g., temperature, air pressure, or projection direction). Since the display quality of the projected image depends on the synchronization between the switching signal OFS_LS received by the light source 50 and the driving signals received by the piezoelectric actuators, if the control unit 300 does not adjust the equations of motion of the motion trajectory calculated based on the first driving signal V₁ and the second driving signal V₂ according to the sensed phase difference or phase delay, the equations of motion cannot represent the actual motion trajectory, resulting in image distortion or blurring on the target surface TS.

To address the aforementioned issue, the control unit 300 may adjust the first phase φ₁ of the first driving signal V₁ based on the first phase variation δ₁ of the first sensing signal V₁″, for example, by adjusting φ₁ to φ₁+δ₁ (i.e., step S202a in FIG. 14B). The control unit 300 may adjust the second phase φ₂ of the second driving signal V₂ based on the second phase variation δ₂ of the second sensing signal V₂″, for example, by adjusting φ₂ to φ₂+δ₂ (i.e., step S202b in FIG. 14C). However, the present invention is not limited thereto. In another embodiment, if the first sensing amplitude A₁″ of the first sensing signal V₁″ deviates from a predetermined value (i.e., the rotation angle is too large or too small), the control unit 300 may adjust the first driving amplitude A₁ of the first driving signal V₁ based on the first sensing amplitude A₁″. Similarly, if the second sensing amplitude A₂″ of the second sensing signal V₂″ deviates from a predetermined value (i.e., the rotation angle is too large or too small), the control unit 300 may adjust the second driving amplitude A₂ of the second driving signal V₂ based on the second sensing amplitude A₂″. In yet another embodiment, the control unit 300 may simultaneously adjust both the phase and the driving amplitude of the driving signal based on the phase variation and sensing amplitude of the sensing signal.

Subsequently, the control unit 300 calculates the equation of motion of the corrected motion trajectory based on the adjusted first driving signal V₁ and second driving signal V₂ (i.e., step S101 in FIG. 14A): D₁=B₁sin(ω₁t+φ₁+δ₁) and D2=B2sin(ω2t+φ2+δ2), wherein D₁ represents a displacement of the light beam LB on the target surface TS along the scanning direction SD1, and D represents a displacement of the light beam LB on the target surface TS along the scanning direction SD2, B₁ represents a maximum displacement of the motion trajectory along the scanning direction SD1, and B₂ represents a maximum displacement of the motion trajectory along the scanning direction SD2 (as shown in FIG. 1).

Constructing the scanning matrix M_{S} and the image matrix M_{I} respectively based on the corrected equations of motion and the image IM to be projected, and outputting a light source control signal CS_LS based on a comparison result between the scanning matrix M_{S} and the image matrix M_{I} (i.e., step S102 in FIG. 14A). Next, outputting a switching signal OFS_LS to the light source 50 according to the light source control signal CS_LS, such that when the light beam LB scans along the motion trajectory on the target surface TS, the light source 50 is switched on or off according to the switching signal OFS_LS (i.e., step S103 in FIG. 14A). In a modified embodiment, the signal compensation method further includes synchronizing the first driving signal V₁, the second driving signal V₂, and the switching signal OFS_LS based on a clock signal CLK before the switching signal OFS_LS is output to the light source 50 (i.e., step S103A in FIG. 15).

In the signal compensation method described above, the control unit 300 adjusts the phase (or driving amplitude) of the driving signals of the piezoelectric actuators based on the phase variation (or sensing amplitude) of the sensing signals, and the equations of motion of the motion trajectory calculated based on the adjusted driving signals is accordingly updated. Therefore, the adjusted equations of motion can truly reflect the actual motion trajectory of the light beam LB on the target surface TS, and the light source control signal CS_LS is generated based on the corrected scanning matrix. Accordingly, the projection system 10 can maintain high projection quality even under environmental disturbances.

To sum up, in the projection system according to an embodiment of the present invention, the configuration of the plurality of first transmission members connecting the first actuation structure and the second actuation structure, and the plurality of second transmission members connecting the second actuation structure and the sensing structure can significantly reduce the nonlinearity in the oscillation of the rotating member of the piezoelectric actuator, thereby improving the sharpness of the projected image of the projection system. In addition, the first actuation structure, which is connected between the second actuation structure and the frame, not only serves a fixing function but also provides additional linear actuation force. The linear actuation force, using the second actuation structure as a lever arm, generates additional torque to twist the rotating member, thereby achieving a greater rotation angle. In the signal compensation method of the projection system according to an embodiment of the present invention, the control unit adjusts the driving amplitude of the driving signal based on the sensing amplitude of the sensing signal, and/or adjusts the phase of the driving signal based on the phase variation of the sensing signal, so as to compensate for the influence of external disturbances on the piezoelectric actuator and thereby maintain the display quality of the projected image.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the present invention is provided to comply with the rules requiring an abstract, which will allow a searcher to quickly ascertain the subject matter of the technical present invention of any patent issued from this present invention. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present invention is intended to be dedicated to the public regardless of whether the element or component is explicitly recited in the following claims.

What is claimed is:

1. A projection system, comprising:
a light source, configured to provide a light beam;
at least one piezoelectric actuator, configured to project the light beam from the light source onto a target surface, each of the at least one piezoelectric actuator comprising:
a frame, having an opening;
a rotating member, disposed in the opening and extending along an axial direction to form a rotating shaft structure, wherein the rotating shaft structure has an axis extending in the axial direction, and the rotating member is adapted to reciprocally oscillate relative to the frame about the axis;
a first actuation structure, disposed between the frame and the rotating member and connected to the frame;
a second actuation structure, disposed in the opening, wherein the second actuation structure is located on opposite sides of the rotating member along the axial direction and connected to the rotating member via the rotating shaft structure;
a sensing structure, disposed between the frame and the rotating member and connected to the frame, wherein the first actuation structure and the sensing structure are symmetrically disposed on opposite sides of the axis of the rotating shaft structure;
a plurality of first transmission members, connecting the first actuation structure to the second actuation structure, wherein the first actuation structure is coupled to the rotating member via the second actuation structure and the plurality of first transmission members; and
a plurality of second transmission members, connecting the second actuation structure to the sensing structure, wherein the sensing structure is coupled to the rotating member via the second actuation structure and the plurality of second transmission members,
wherein the at least one piezoelectric actuator includes a first piezoelectric actuator, the first actuation structure and the second actuation structure of the first piezoelectric actuator receive a first driving signal and undergo deformation to drive oscillation of the rotating member of the first piezoelectric actuator, such that the light beam scans along a motion trajectory on the target surface, the rotating member in oscillation of the first piezoelectric actuator actuates the sensing structure of the first piezoelectric actuator via the second actuation structure and the plurality of second transmission members of the first piezoelectric actuator, so that the sensing structure of the first piezoelectric actuator undergoes corresponding deformation and generates a first sensing signal,
the first driving signal satisfies the following equation: V₁=A₁sin(ω₁t+φ₁), and the first sensing signal satisfies the following equation: V₁″=A₁″sin(ω₁t+φ₁+δ₁), wherein V₁ is the first driving signal, A₁ is a first driving amplitude, ω₁ is a first frequency, φ₁ is a first phase, t is time, V₁″ is the first sensing signal, A₁″ is a first sensing amplitude, and δ₁ is a first phase variation; and
a control unit, electrically coupled to the at least one piezoelectric actuator and the light source, wherein the control unit is adapted to adjust the first driving amplitude A₁ of the first driving signal V₁ based on the first sensing amplitude A₁″ of the first sensing signal V₁″, and/or to adjust the first phase of the first driving signal V₁ from φ₁ to φ₁+δ₁ based on the first phase variation δ₁ of the first sensing signal V₁″.

2. The projection system according to claim 1, wherein the at least one piezoelectric actuator further includes a second piezoelectric actuator, the first actuation structure and the second actuation structure of the second piezoelectric actuator receive a second driving signal and undergo deformation to drive oscillation of the rotating member of the second piezoelectric actuator, such that the light beam scans along the motion trajectory on the target surface, the rotating member in oscillation of the second piezoelectric actuator actuates the sensing structure of the second piezoelectric actuator via the second actuation structure and the plurality of second transmission members of the second piezoelectric actuator, so that the sensing structure of the second piezoelectric actuator undergoes corresponding deformation and generates a second sensing signal, the second driving signal satisfies the following equation: V₂=A₂sin(ω₂t+φ₂), and the second sensing signal satisfies the following equation: V₂″=A₂″sin(ω₂t+φ₂+δ₂), wherein V₂ is the second driving signal, A₂ is a second driving amplitude, ω₂ is a second frequency, φ₂ is a second phase, V₂″ is the second sensing signal, A₂″ is a second sensing amplitude, and δ₂ is a second phase variation,
wherein the control unit is further adapted to adjust the second driving amplitude A₂ of the second driving signal V₂ based on the second sensing amplitude A₂″ of the second sensing signal V₂″, and/or to adjust the second phase of the second driving signal V₂ from φ₂ to φ₂+δ₂ based on the second phase variation δ₂ of the second sensing signal V₂″.

3. The projection system according to claim 2, further comprising:
a driving circuit, electrically coupled to the control unit and to both the first actuation structure and the second actuation structure of each of the first piezoelectric actuator and the second piezoelectric actuator, wherein the driving circuit outputs the first driving signal and the second driving signal to the first piezoelectric actuator and the second piezoelectric actuator, respectively, based on the first driving amplitude, the first phase, the second driving amplitude, and the second phase provided by the control unit; and
a sensing circuit, electrically coupled to the control unit and to the sensing structure of each of the first piezoelectric actuator and the second piezoelectric actuator, wherein the first sensing signal and the second sensing signal are processed by the sensing circuit and then output to the control unit.

4. The projection system according to claim 2, wherein the control unit is adapted to calculate equations of motion, expressed as: D₁=B₁sin(ω₁t+φ₁+δ₁) and D₂=B₂sin(ω₂t+φ₂+δ₂), for the motion trajectory based on the first driving signal and the second driving signal, wherein D₁ represents a displacement of the light beam on the target surface along a first scanning direction, D₂ represents a displacement of the light beam on the target surface along a second scanning direction, B₁ represents a maximum displacement of the motion trajectory along the first scanning direction, and B₂ represents a maximum displacement of the motion trajectory along the second scanning direction, and the first scanning direction is perpendicular to the second scanning direction.

5. The projection system according to claim 4, wherein the control unit is further adapted to respectively construct a scanning matrix and an image matrix based on the equations of motion and an input image, and to output a light source control signal based on a comparison result between the scanning matrix and the image matrix.

6. The projection system according to claim 5, further comprising:
a driving circuit, electrically coupled to the control unit and to both the first actuation structure and the second actuation structure of each of the first piezoelectric actuator and the second piezoelectric actuator, wherein the driving circuit outputs the first driving signal and the second driving signal to the first piezoelectric actuator and the second piezoelectric actuator, respectively, based on the first driving amplitude, the first phase, the second driving amplitude and the second phase provided by the control unit; and
a light source driving unit, electrically coupled to the light source and the control unit, wherein the light source driving unit receives the light source control signal from the control unit and outputs a switching signal to the light source.

7. The projection system according to claim 6, wherein the light source driving unit and the driving circuit receive a clock signal to synchronize the first driving signal, the second driving signal, and the switching signal.

8. The projection system according to claim 1, wherein each of the at least one piezoelectric actuator further includes:
an elastic member, connecting the frame to the second actuation structure along the axis of the rotating shaft structure.

9. The projection system according to claim 1, wherein the control unit is adapted to calculate an equation of motion, expressed as: D₁=B₁sin(ω₁t+φ₁+δ₁), for the motion trajectory based on the first driving signal, wherein D₁ represents a displacement of the light beam on the target surface along a first scanning direction, and B₁ represents a maximum displacement of the motion trajectory along the first scanning direction.

10. A signal compensation method of a projection system, wherein the projection system includes a light source and at least one piezoelectric actuator, the light source is configured to provide a light beam, the at least one piezoelectric actuator is configured to project the light beam onto a target surface and scan along a motion trajectory, each of the at least one piezoelectric actuator includes a frame, a rotating member, a first actuation structure, a second actuation structure, and a sensing structure, each of the first actuation structure and the sensing structure is coupled to the rotating member via the second actuation structure and connected to the frame, and the signal compensation method of the projection system comprises:
inputting a first driving signal to the first actuation structure and the second actuation structure of a first piezoelectric actuator of the at least one piezoelectric actuator, such that the first actuation structure and the second actuation structure of the first piezoelectric actuator undergo deformation and drive oscillation of the rotating member of the first piezoelectric actuator, the rotating member in oscillation of the first piezoelectric actuator actuates the sensing structure of the first piezoelectric actuator via the second actuation structure of the first piezoelectric actuator, so that the sensing structure of the first piezoelectric actuator undergoes corresponding deformation and generate a first sensing signal, wherein the first driving signal satisfies the following equation: V₁=A₁sin(ω₁t+φ₁), the first sensing signal satisfies the following equation: V₁″=A₁″sin(ω₁t+φ₁+δ₁), wherein V₁ is the first driving signal, A₁ is a first driving amplitude, ω₁ is a first frequency, φ₁ is a first phase, t is time, V₁″ is the first sensing signal, A₁″ is a first sensing amplitude, and δ₁ is a first phase variation; and
adjusting the first driving amplitude A₁ of the first driving signal V₁ based on the first sensing amplitude A₁″ of the first sensing signal V₁″, and/or adjusting the first phase of the first driving signal V₁ from φ₁ to φ₁+δ₁ based on the first phase variation δ₁ of the first sensing signal V₁″.

11. The signal compensation method of the projection system according to claim 10, further comprising:
inputting a second driving signal to the first actuation structure and the second actuation structure of a second piezoelectric actuator of the at least one piezoelectric actuator, such that the first actuation structure and the second actuation structure of the second piezoelectric actuator undergo deformation and drive oscillation of the rotating member of the second piezoelectric actuator, the rotating member in oscillation of the second piezoelectric actuator actuates the sensing structure of the second piezoelectric actuator via the second actuation structure of the second piezoelectric actuator, so that the sensing structure of the second piezoelectric actuator undergoes corresponding deformation and generate a second sensing signal, wherein the second driving signal satisfies the following equation: V₂=A₂sin(ω₂t+φ₂), the second sensing signal satisfies the following equation: V₂″=A₂″sin(ω₂t+φ₂+δ₂), wherein V₂ is the second driving signal, A₂ is a second driving amplitude, ω₂ is a second frequency, φ₂ is a second phase, V₂″ is the second sensing signal, A₂″ is a second sensing amplitude, and δ₂ is a second phase variation; and
adjusting the second driving amplitude A₂ of the second driving signal V₂ based on the second sensing amplitude A₂″ of the second sensing signal V₂″, and/or adjusting the second phase of the second driving signal V₂ from φ₂ to φ₂+δ₂ based on the second phase variation δ₂ of the second sensing signal V₂″.

12. The signal compensation method of the projection system according to claim 11, further comprising:
calculating equations of motion, expressed as: D₁=B₁sin(ω₁t+φ₁+δ₁) and D₂=B₂sin(ω₂t+φ₂+δ₂), for the motion trajectory based on the first driving signal and the second driving signal, wherein D₁ represents a displacement of the light beam on the target surface along a first scanning direction, D₂ represents a displacement of the light beam on the target surface along a second scanning direction, B₁ represents a maximum displacement of the motion trajectory along the first scanning direction, B₂ represents a maximum displacement of the motion trajectory along the second scanning direction, and the first scanning direction is perpendicular to the second scanning direction.

13. The signal compensation method of the projection system according to claim 12, further comprising:
constructing a scanning matrix and an image matrix respectively based on the equations of motion and an image to be projected, and outputting a light source control signal based on a comparison result between the scanning matrix and the image matrix.

14. The signal compensation method of the projection system according to claim 13, further comprising:
outputting a switching signal to the light source based on the light source control signal, wherein the light source is switched on or off according to the switching signal as the light beam scans along the motion trajectory on the target surface.

15. The signal compensation method of the projection system according to claim 14, further comprising:
synchronizing the switching signal, the first driving signal and the second driving signal based on a clock signal before the switching signal is output to the light source.
